(19) United States
(12) Patent Application Publication
(10) Pub. No.: US 2007/0080827 A1
(43) Pub. Date: Apr. 12, 2007

(54) Automatic charging system for parking vehicles

(76) Inventor: Ching Tiem Huang, Taipei Hsien (TW)

Correspondence Address: CHING TIEM HUANG, 235 Chung - Ho, Box 8-24, Taipei, TW

(21) Appl. No.: 11/243,935

(22) Filed: Oct. 6, 2005

(51) Int. Cl. G08B 21/00

(52) U.S. Cl. 340/945

(57) ABSTRACT

An automatic charging system for parking vehicles comprises a controller, at least one parking charge unit, and other peripherals. The controller comprises an image identifier for identifying images for fining license plate and identifying characters of the license plates; a ticket processing unit for deciding parking time periods of vehicles, calculating charges for the parking time periods; a data transfer unit for receiving and transferring all data about the system; and an accounting unit for calculating the charge fees. Each parking unit is connected to the controller and comprises a camera for capturing images having the license plates of vehicles; a detector for detecting positioning of cars; and a printer for printing tickets. The peripheral includes a memory for recording all the data of the system; and a timer for determining the entering and leaving times of a vehicle for determining the parking time period of a vehicle.

### FIELD OF THE INVENTION

The present invention relates to vehicle parking, and in particular to an automatic charging system for parking vehicles, wherein the charge of parking fee of vehicles can be performed automatically. No charge person is necessary. Thereby, the parking fees can be received without any lost and cost in labors are saved.

### BACKGROUND OF THE INVENTION

Currently, the parking space is managed manually, the management records the parking states of the vehicles so as to determine the parking fees. However the cost is high and the driver will fee inconvenient for paying the parking fees. Furthermore, the time from the parking time to the recording time cannot be recorded for charge. This will induce the lose in the charge of parking. It is estimated that the lose is about 10% of the all the fees necessary to be received. Thereby there is an eager demand for improving this defect.

There are some prior art discussed about the charge of parking of vehicles. The followings are some example prior art patents about this field.

In one prior art, U.S. Pat. No. 5,498,859, an invention of “Parking card for the charge-related actuation of a parking barrier” is disclosed, wherein a parking card is intended for the charge-related actuation of a parking barrier and is in the form of a sheet-like plastic piece having a front side and rear side and having a machine-readable data carrier for storing car-park information and user information and, if appropriate, the entrance time and departure time. In order to provide a parking card which is easily constructed and can be handled with ease and permits the installation of an inexpensive parking service system, the invention provides that the plastic piece (1) is in the form of a round coin, on or in which there is mounted an identification and/or communication component (5) which operates in a contactless manner and comprises a chip and a data-transmission device which emits electromagnetic waves.

In another prior art, U.S. Pat. No. 5,003,520, an invention of “Time accounting system, in particular for parking subject to charge” is disclosed, wherein a time accounting system for accounting parking subject to charge periods which includes a card having an electronic memory in which each memory location can be individually and irreversibly written in order to represent a time unit credit allocated to the holder of the card. The system also includes a portable case in which the card can be inserted and which has an internal clock circuit and a coupling circuit, as well as a writing circuit. The case is designed with means for temporary storage of a time unit credit which is activable if the time credit remaining in the inserted card is less than the parking time of the holder.

In another prior art, U.S. Pat. No. 5,437,901, an invention of “Parking card for the charge-related actuation of a parking barrier” is disclosed, wherein a parking card for the charge-related actuation of a parking barrier comprises: a round plastic piece having a front side and a rear side; an integrated electronic component formed within said plastic piece for the storing of parking information; a peripheral border region of said plastic piece with a radially outwardly tapering thickness.

However above mentioned three prior arts and some known prior art do not disclose any structure for automatically charge of parking fees for vehicles so as to save the work of persons to record and calculate the parking fees.

### SUMMARY OF THE INVENTION

Accordingly, the primary object of the present invention is to provide an automatic charging system for parking vehicles, wherein the charge of parking fee of vehicles can be performed automatically. No charge person is necessary. Thereby, the parking fees can be received without any lost and cost in labors are saved.

To achieve above objects, the present invention provides an automatic charging system for parking vehicles. The system comprises a controller, at least one parking charge unit, and other peripherals. The controller comprises an image identifier for identifying images for fining license plate and identifying characters of the license plates; a ticket processing unit for deciding parking time periods of vehicles, calculating charges for the parking time periods; a data transfer unit for receiving and transferring all data about the system; and an accounting unit for calculating the charge fees. Each parking unit is connected to the controller and comprises a camera for capturing images having the license plates of vehicles; a detector for detecting positioning of cars; and a printer for printing tickets. The peripheral includes a memory for recording all the data of the system; and a timer for determining the entering and leaving times of a vehicle for determining the parking time period of a vehicle.

The various objects and advantages of the present invention will be more readily understood from the following detailed description when read in conjunction with the appended drawing.

### BRIEF DESCRIPTION OF THE DRAWINGS

FIG. 1 shows the main component structure of the present invention, specifically the components of the controller is illustrated.

FIG. 2 shows the main components of the parking charge unit of the present invention.

FIG. 3 shows the arrangement of the present invention as the present invention is applied to a parking field.

FIG. 4 shows the situation of a vehicle parking in a parking space, which is suitable for the use of the present invention.

FIG. 5 shows the main flow diagram of the present invention.

FIG. 6 shows a first sub-loop of the present invention.

FIG. 7 shows a second sub-loop of the present invention.

FIG. 8 shows a third sub-loop of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

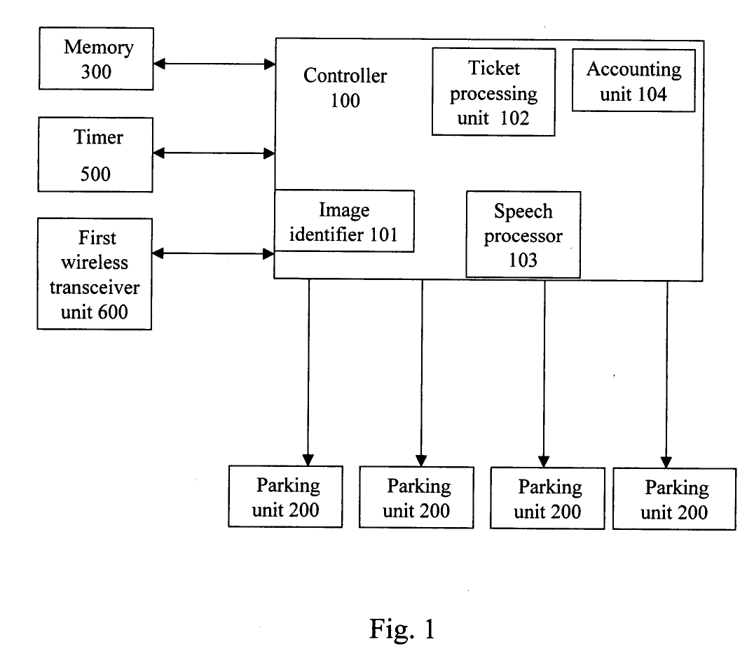

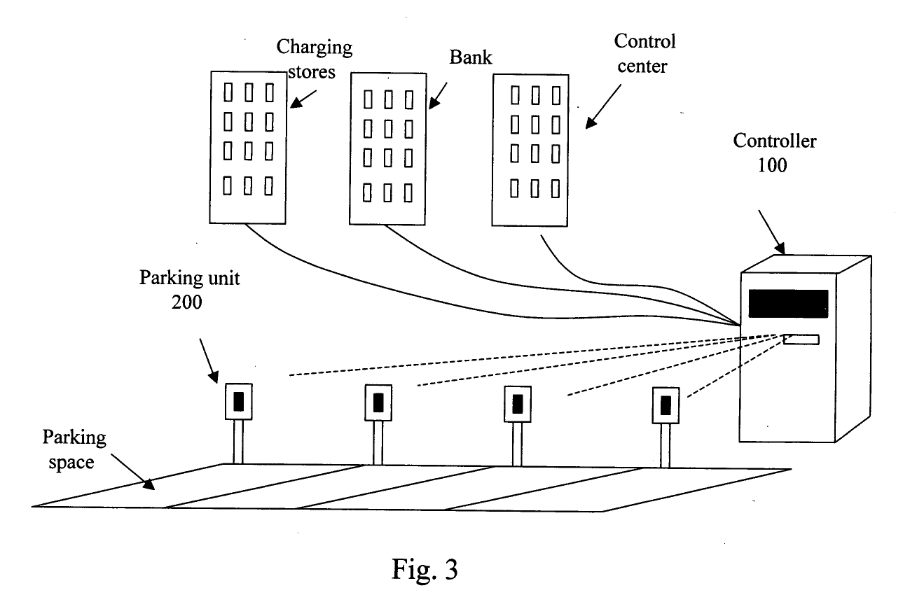

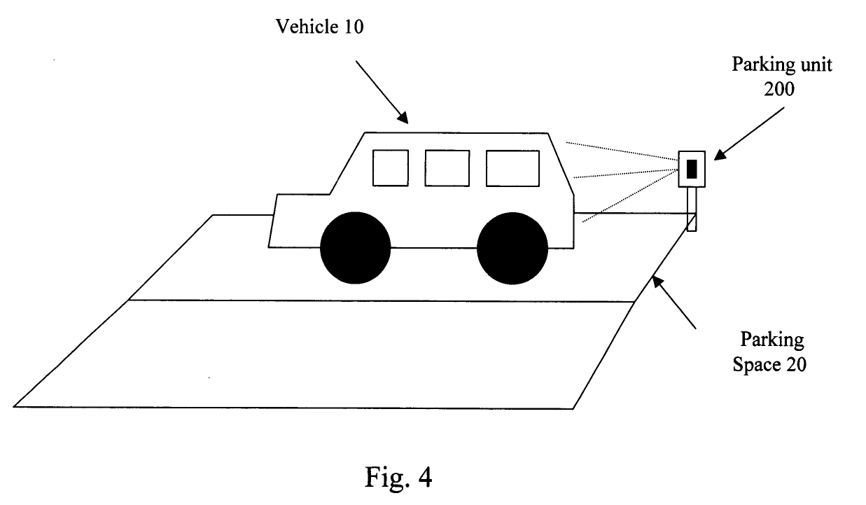

With reference to FIGS. 1 to 4, the component structure of the present invention is illustrated. The present invention is related to an automatic charging management system for controlling the charging process and positioning of the parking vehicles.

The system mainly includes a controller 100 which may be for example a central processing unit, a microprocessor, a micro-controller, etc. The controller 100 is connected to at least one parking unit 200. In FIG. 1, there are five parking units 200 are displayed. However the number of the parking unit 200 is not confined by five, other number is permissible in the present invention.

The controller 100 has the following devices.

An image identifier 101 serves for identifying the image from a camera for finding a license plate and identifying the characters of the license plate.

A ticket processing unit 102 serves for deciding the parking time period of a vehicle, calculating the charges for the parking time period and printing the ticket.

A speech processor 103 serves to process all the speeches required by the system.

An accounting unit 104 serves for calculating the charge fees. The accounting unit 104 is connected to a far accounting center (not shown), for example, a bank so that the fee data is stored. Thereby the parking fee can be paid through the account center. The user need not pay the fees by himself or herself.

A first wireless transceiver unit 105 is connector to the controller for receiving and transmitting wireless signals between the controller 100 and the parking unit 200 or between the controller 100 and other remoter unit, such as an accounting center in bank or other charging center.

The controller 100 further includes the following peripheral devices.

A memory 300 serves for recording all the data of the system, such as the images, license plates, charges, parking times. The memory 300 may be one of all possible recording device, such as DRAM, RAM, SRAM, flash memory, etc.

A timer 500 serves for determining the entering and leaving times of a vehicle so as to determining the parking time period of a vehicle.

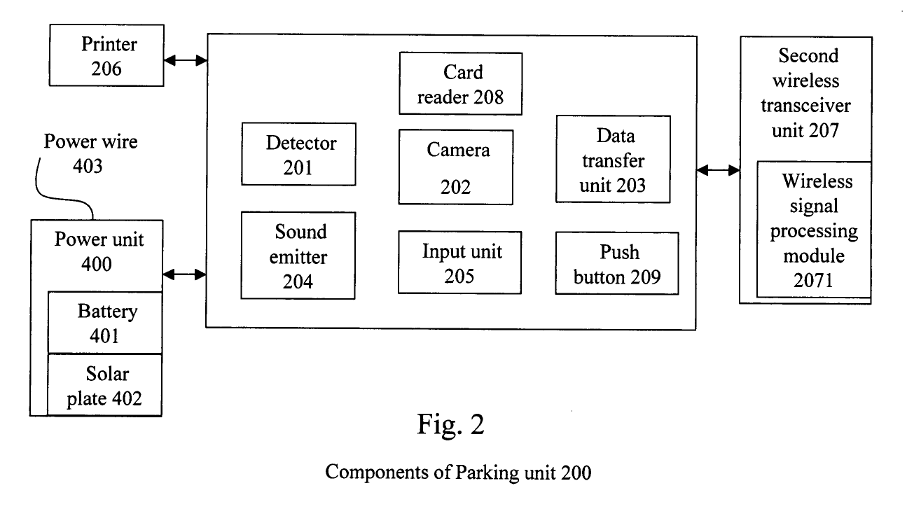

Referring to FIG. 2, each parking unit 200 includes the following elements.

A detector 201 serves for detecting the positioning of the car. The detector can be any kind of detectors, such as infrared detectors, microwave detectors, RF (radio frequency) detectors, etc.

A camera 202 serves for capturing an image of the license plate of a vehicle and transferring the images to the image identifier 103.

A data transfer unit 203 serves to receive and transfer all data about the system. The data are such as ticket numbers, charges, vehicle license plate numbers, times, time periods, etc.

A sound emitter 204 serves to emit sounds for guiding the positioning of the vehicle to predetermined positions. The sound emitter 201 receives the signals from the speech processor 103.

An input unit 205, such as a keyboard, a keypad, or a speech receiver, is included. People can input data to the system of the present invention. For example, a manager of the parking space can input data (for example, parking times, license plate numbers, etc.) to the system as the system is malfunctioned. The input device 205 may contain a display.

A printer 206 serves to print the tickets or other documents of the system.

A second wireless transceiver unit 207 serves for transmitting signals or receiving signals wirelessly. The second wireless transceiver unit 207 further comprises a wireless signal processing module 2071 for different protocols, such as GSM, GPRS, WAP, PHS, blue tooth modules, etc. By above mentioned wireless receiver unit and wireless modules, the users can pay the parking charges wirelessly by a handset, a notebook, or a wireless device in the vehicle.

A card reader 208 serves for reading data from the driver. If the account unit receives an enter signal and a leaving signal from the card reader, the accounting unit will charge the parking fee for an account of the user by wired way or wireless way.

A push button 209 serves to stop of the charge operation so as to output a ticket to the driver.

A power unit 400 serves to receiver power, the power source may be from a power wire 403 connected to a further power source (not shown) or a battery set 401. At least one solar energy plate 402 can be adhered to a device having the system of the present invention for providing power to the system. The power can be stored in the battery set 401.

A display serves for displaying the related data, such as parking times, parking fees, license plate numbers, the surplus money in the user's account or other attention notes.

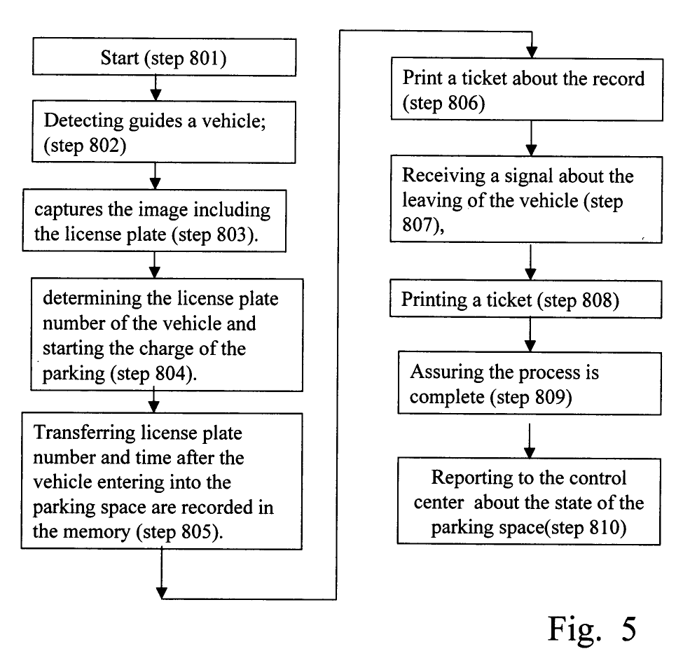

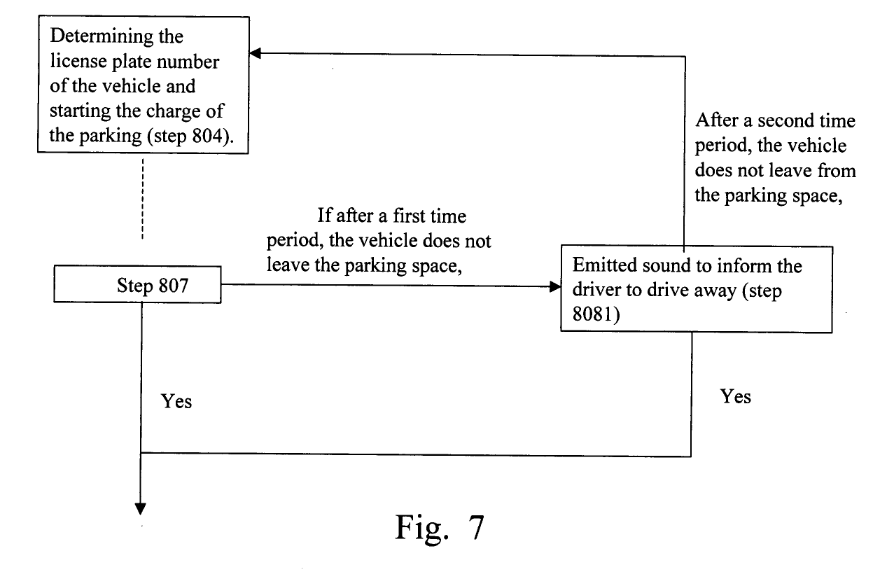

With referring to FIGS. 5 to 8, and further to the FIGS. 1 to 4, the operation of the present invention will be described herein. The process is started from step 801. When a vehicle 10 enters into a parking space 20, the detector 201 firstly detects the position of the vehicle and guides the vehicle to a predetermined position (step 802). In general, a predetermined position is a position which is suitable for the detecting of the license plate number and is a safe area.

Then the camera 202 captures the image including the license plate (step 803). Then the image is transferred to the image identifier for determining the license plate number of the vehicle (step 804).

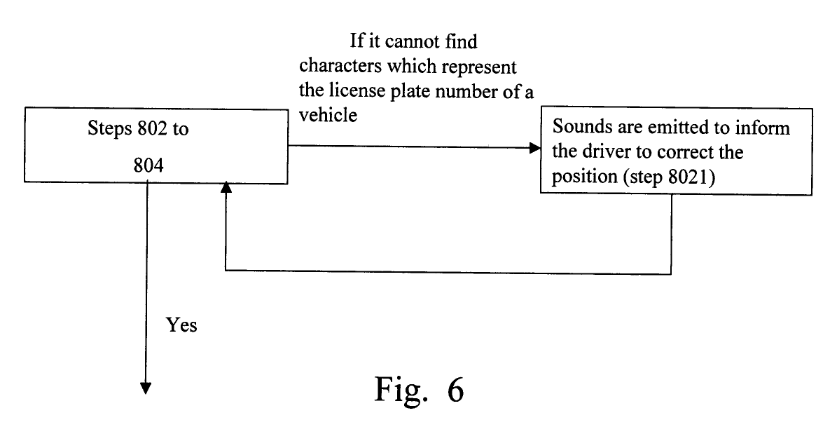

Referring to FIG. 6, the steps from 802 to 804 includes a sub-loop 8041. If it cannot find characters which represent the license plate number of a vehicle, then a sound is emitted from the sound emitter to inform the driver to correct the position of the vehicle so that the vehicle can be located in predetermined positions (step 8021).

If a plurality of characters are determined which can represent a license plate number of a vehicle, than the license plate number and the time after the vehicle enters into the parking space are recorded in the memory (step 805). A ticket may be printed to the driver as a recording of the parking data (step 806).

When the system receives a signal about the leaving of the vehicle (step 807), the printer will print a ticket (step 808) (which indicate the parking time, leaving time, time period, charges, license plate number, and ticket number) to the driver so that the driver can pay the charges based on this ticket. In the present invention, the signals about the leaving of the vehicles include a push button signals, a wireless signal or a signal from a card reader to inform the leaving of the vehicle.

The step 807 includes the following sub-loop. If after a first time period of such as, 5 minute, the vehicle does not leave the parking space, the sound emitter 204 will emit a sound to alter the driver to drive the car away otherwise the timing will be continue after a second time period (step 8081). If the second time period has elapsed, the process is directed to the step 803. Namely, the camera captures the image for determining a license plate number and then does the following steps.

However if the system discovers that a vehicle within the parking space is moved, the printer 206 will print a ticket (809). The sound emitter may emit sounds to inform the driver to take ticket.

Furthermore, the method of the present invention further comprises the steps of receiving a wireless signal from a wireless device of a user so as to determine the license number of the vehicle.

Then the system determines whether the process is complete (step 809). When the ticket is taken away or the charged is paid by reading indications from a card or a wireless device, the process is complete.

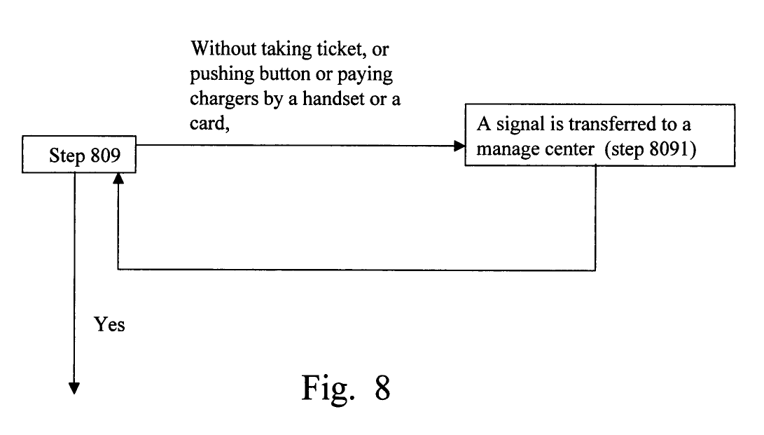

If the process is not complete. Referring to FIG. 8, the stop 809 includes the following sub-steps. If the vehicle is driven away from the parking space without taking ticket, or pushing button or paying chargers by a handset or a card, a signal is transferred to a manage center, which may be a police center or a control center of a parking field to inform the controller to make predetermined processes (step 8091). However the driver can pay the parking fee based on the ticket in any paying center, such as a bank, the manage center, or other designate stores, such as sever-eleven stores or by a handset to transfer a paying message to the accounting unit or by an allowed card to be scanned by the scanner.

After the vehicle leaves from the parking space, the system will inform the control center that the parking space is now ready for a further vehicle (step 810).

Furthermore, if the driver has registered to the system, the system can emit all the data about the parking of the vehicle to the driver wireless.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An automatic charging system for parking vehicles comprising:
a controller further comprising:
an image identifier for identifying images for fining license plate and identifying characters of the license plates;
a ticket processing unit for deciding parking time periods of vehicles, calculating charges for the parking time periods;
a data transfer unit for receiving and transferring all data about the system; and
an accounting unit for calculating the charge fees;
a memory connected to the controller for recording all the data of the system;
a timer for determining the entering and leaving times of a vehicle so as to determining the parking time period of a vehicle; and
at least one parking unit connected to the controller; the at least one parking unit comprising:
a camera for capturing images having the license plates of vehicles;
a detector for detecting positioning of cars; and
a printer for printing tickets.

2. The automatic charging system for parking vehicles as claimed in claim 1, wherein data transmission between the controller and the parking unit is positioned wirelessly.

3. The automatic charging system for parking vehicles as claimed in claim 2, wherein a first wireless transceiver unit is installed in the controller for receiving and transmitting wireless signals between the controller and the parking unit or between the controller and other remoter unit; and
a second wireless transceiver unit is installed in the parking unit serves for transmitting data or receiving data wireless.

4. The automatic charging system for parking vehicles as claimed in claim 3, wherein the second wireless transceiver unit further comprises a wireless signal processing module for different protocols including at least one of GSM modules, at least one GPRS modules, at least one WAP modules, at least one PHS modules and at least one blue tooth modules.

5. The automatic charging system for parking vehicles as claimed in claim 2, wherein the charges are paid by a wireless device.

6. The automatic charging system for parking vehicles as claimed in claim 3, wherein the wireless device is selected from one of a handset, a notebook, a computer, and a car wireless device.

7. The automatic charging system for parking vehicles as claimed in claim 1, wherein the detector is selected from one of infrared detectors, microwave detectors, RF (radio frequency) detectors.

8. The automatic charging system for parking vehicles as claimed in claim 1, further comprising a card reader for reading data from a card.

9-10. (canceled)

11. The automatic charging system for parking vehicles as claimed in claim 1, wherein a power unit serves to receiver power, and the power unit includes at least one solar energy plate and at least one battery.

12. The automatic charging system for parking vehicles as claimed in claim 1, wherein the data recorded in the memory includes ticket numbers, charges, vehicle license plate numbers, times, and time periods.

13. The automatic charging system for parking vehicles as claimed in claim 1, further comprising
a speech processor serves to process all the speeches required by the system and sends sound signals to the sound emitter; and
a sound emitter for emitting sounds for guiding the positioning of the vehicle to predetermined positions.

14. The automatic charging system for parking vehicles as claimed in claim 1, further comprising:
an accounting unit connected to a far accounting center so that the fee data is stored; thereby the parking fee can be paid through the account center.

15. The aromatic charging system for parking vehicles as claimed in claim 1, further comprising:
an input unit so that user can input data to the system.

16. A method for automatic charging parking fees of vehicles; comprising the steps of:
detecting a position of the vehicle and guides the vehicle to a predetermined position;
capturing an image including the license plate;
transferring the image to an image identifier for determining the license plate number of the vehicle:
recording the license plate number and the time after the vehicle enters into the parking space in the memory;
receiving a signal for determining that the vehicle will leave the parking space;
after determining that the vehicle will leave, printing a ticket which indicate the parking time, leaving time, time period, charges, license plate number, and ticket number to the driver so that the driver can pay the charges based on this ticket.

17. The method as claimed in claim 16, wherein if after a first time period, the vehicle does not leave the parking space, a sound emitter will emit a sound to alter the driver to drive the vehicle away otherwise the timing will be counted again, and after a second time period, if the second time period has elapsed, the process is repeated;

18. The method as claimed in claim 16, wherein the charged is paid by reading a data from a card so as to charge fees from an account belong to the driver of the vehicle.

19. The method as claimed in claim 16, wherein the charged is paid by receiving a signal wirelessly so as to charge fees from an account belong to the users.

20. The method as claimed in claim 16, wherein if the vehicle is driven away from the parking space without taking ticket, or pushing button or paying the parking charge by a wireless device or a card, a signal is transferred to a control center.

21. The method as claimed in claim 16, wherein if it cannot find characters which represent the license plate number of a vehicle, then a sound is emitted from the sound emitter to inform the driver to correct the position of the vehicle so that the vehicle can be located in predetermined positions.

22. The method as claimed in claim 21, further comprising the steps of receiving a wireless signal from a wireless device of a user so as to determine the license number of the vehicle.
